(19) United States
(12) Patent Application Publication
(10) Pub. No.: US 2009/0020913 A1
(43) Pub. Date: Jan. 22, 2009

(54) Solution Casting Method

(75) Inventor: Satoshi Sakamaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/886,880

(22) PCT Filed: Mar. 17, 2006
(86) PCT No.: PCT/JP2006/305898

§ 371 Date: Sep. 21, 2007

(30) Foreign Application Priority Data
Mar. 22, 2005 (JP) 2005-082539

(51) Int. Cl. B29C 55/00

(52) U.S. Cl. 264/291

(57) ABSTRACT

A dope made from TAC, additives and solvent is cast onto a belt to form a casting film. When having self-supporting property, the casting film is peeled from the belt as a wet film (120) and transported into a tenter dryer (17). The wet film (120) is stretched in its widthwise direction in a stretch area (131) and relaxed in the widthwise direction in a relaxation area (132). When a stretch rate of the width of the wet film (120) after being held for 0.1 minute is a stretch rate X (%) and a maximum relaxation rate of the width of the wet film (120) per unit time in the relaxation area (132) is a relaxation speed Y (%/min), the stretching and relaxing is performed so as to satisfy the following equation:

5X+Y<10

### TECHNICAL FIELD

The present invention relates to a solution casting method.

### BACKGROUND ART

A cellulose acylate film is formed from cellulose acylate. For example, a cellulose triacetate (hereinafter TAC) film formed from TAC whose averaged acetylation degree is 57.5% to 62.5% has high strength and incombustibility, and is therefore used as a film base of photosensitive materials and the like. Furthermore, as excellent in optical isotropy, the TAC film is used for an optical compensation film, such as a wideview film, and a protective film for a polarizing filter in a liquid crystal display (LCD) whose market becomes larger recently.

The TAC film is usually produced by a solution casting method, in which the produced film has more excellent physical property (optical properties and the like) than other methods, such as a melt-extrusion method. In the solution casting method, a polymer solution (hereinafter dope) is produced by dissolving a polymer in a mixed solvent, while a main component of the mixed solvent is dichloromethane or methyl acetate. The dope is cast by a casting die onto a support, with forming a bead, to form a casting film. The casting film having a self-supporting property is peeled from the support as a film (hereinafter wet film). The wet film is dried by a tenter dryer while being stretched and relaxed in its widthwise direction, thereby improving planarity of a surface of the wet film. The dried wet film is fed out from the tenter dryer as a film and then wound up (for instance, see Japan Institute of Invention and Innovation (JIII) JOURNAL of Publication No.2001-1745).

When the wet film is applied tension thereto in the widthwise direction in the tenter dryer, however, a bowing phenomenon may occur. It is known that the bowing phenomenon causes misalignment of a slow axis in the widthwise direction of the wet film. That is, a direction of the slow axis differs from part to part when several parts of the wet film are arbitrarily examined. As a result, a surface condition of the wet film tends to change in the widthwise direction. Since the contrast ratio and the screen brightness of the LCD are increased in the recent years, it is further required to prevent the misalignment of the slow axis of an optical film in the widthwise direction thereof. Especially for the protective film for the polarizing filter, it is highly required to align the slow axis of the optical film because the optical film is usually required to have very low in-plane retardation value (from 0 nm to 5 nm) in order to prevent linear polarization from changing into elliptic polarization, and therefore it is difficult to distinctly orient molecules in either longitudinal direction or widthwise direction thereof.

In order to prevent the occurrence of the bowing phenomenon, adoption of biaxial stretching in producing the polyester film by the melt-extrusion method is often studied. Owing to that, several ameliorative methods are proposed (for instance, see Japanese Patent Laid-Open Publication No.2004-034536). In the solution casting method, however, elasticity modulus of the film varies in accordance with residual amount of solvent. Therefore, it is difficult to control the bowing of the film.

As the methods of preventing the bowing phenomenon in the solution casting method, Japanese Patent Laid-Open Publication No.2002-296422 proposes following methods:

1) making the temperatures in side edge portions of the wet film higher than a middle portion thereof;

2) making the residual amount of solvent in the side edge portions of the wet film larger than the middle portion thereof;

3) dividing the tenter dryer into plural zones whose temperatures are different from one another.

In addition, Japanese Patent Laid-Open Publication No.2004-314529 proposes the method of aligning the direction of the slow axis of the film with the widthwise direction thereof by regulating a change in the residual amount of solvent of the film to 25 wt. % or less in the section in the tenter dryer wherein the side edge portions of the film are held.

However, according to the method of Japanese Patent Laid-Open Publication No.2004-034536, it is necessary to divide the stretching section of the tenter dryer into plural zones whose heat conditions are different from one another. Additionally, the accurate temperature control in the widthwise direction of the wet film is needed. With such configurations, the number of the heating devices and the temperature controlling devices becomes large. As a result, the structure becomes complicated, and the cost for the equipment becomes high. Additionally, the more the wet film is dried in the tenter dryer, the more the planarity of the wet film improves, thereby changing birefringence property of the wet film. However, according to the method of Japanese Patent Laid-Open Publication No.2004-314529, the solvent in the wet film is dried to a certain extent in the tenter dryer. Since the drying of the wet film is limited, it is difficult to adjust the planarity and the birefringence property of the wet film to fall within the desirable range.

The present invention aims to provide a solution casting method capable of producing a film in which a bowing phenomenon is reduced, without special equipments.

### DISCLOSURE OF INVENTION

By keen examination, the inventor found that an bowing occurs when a length of a wet film in its widthwise direction (width) is changed by being stretched and relaxed in the widthwise direction, while being dried in a tenter dryer. The inventor also found that the bowing occurs when speed of changing the width of the wet film is fast. According to the present invention, the bowing is reduced by slowing down the speed of changing the width of the wet film. The inventor further found that the bowing tends to occur right after the wet film enters an entrance of the tenter dryer. The wet film before transferred into the tenter dryer is not stretched in the widthwise direction. The inventor found that the bowing tends to occur when the wet film is transferred into the tenter dryer and held at its both side edges portions to be stretched in the widthwise direction. The inventor further found that the stretching in the widthwise direction, which is performed right after the wet film enters the entrance of the tenter dryer, approximately 5 times more likely to cause the bowing than the relaxation performed later on.

According to the present invention, it is not necessary to change the drying condition, such as the temperature, of the wet film in the widthwise direction. Moreover, the amount of solvent to be dried from the wet film in the tenter dryer is not limited. Furthermore, it is possible to align the direction of the slow axis of the film in the widthwise direction more accurately by changing patterns of the stretching.

In order to achieve the above and other objects, a solution casting method of the present invention includes the steps of:

casting a dope onto a support to form a casting film, the dope containing a polymer and a solvent;

peeling the casting film from the support as a film; and

holding both side edge portions of the film by a holding device and drying the film while transporting, the holding-drying step includes

stretching the film in a widthwise direction to enlarge a width of the film;

relaxing the film in the widthwise direction to narrow the width of the film;

wherein when the width of the film at the time of starting the holding is La (mm) and the width of the film after being held for 0.1 minute is Lb (mm), a stretch rate of the width of the film after being held for 0.1 minute is defined as a stretch rate X (%), which is obtained from an equation: {(La−Lb)/La}×100, whereas a maximum relaxation rate of the width of the film per unit time in the relaxing step is defined as a relaxation speed Y (%/min), the stretch rate X (%) and the relaxation speed Y (%/min) satisfy the following equation:

5X+Y<10

The above equation is more preferably 5X+Y<6, even more preferably 5X+Y<5 and most preferably 5X+Y<1.

The stretch rate X (%) of the width of the film is preferably equal to or less than 1.0% and more preferably equal to or less than 0.50%. The relaxation speed Y (%/min) of the width of the film is preferably equal to or less than 5.0%/min. It is preferable that the polymer is cellulose acylate.

According to the solution casting method of the present invention, when the width of the film at the time of starting the holding is La (mm) and the width of the film after being held for 0.1 minute is Lb (mm), the stretch rate of the width of the film after being held for 0.1 minute is defined as the stretch rate X (%), which is obtained from the equation: {(La−Lb)/La}×100 and the maximum relaxation rate of the width of the film per unit time in the relaxing step is defined as the relaxation speed Y (%/min). The stretch rate X (%) and the relaxation speed Y (%/min) satisfy the equation: 5X+Y<10. Owing to this, the occurrence of the bowing due to the stretching and relaxing of the film can be reduced. Thereby, it is possible to obtain the film with excellent planarity and desired in-plane retardation (Re). The film produced in accordance with the present invention is applicable as an optical film.

It is preferable that at least one of the following conditions is met:

1) the stretch rate X (%) of the width of the film is equal to or less than 1.0%.

2) the relaxation speed Y (%/min) of the width of the film is equal to or less than 5.0%/min.

By satisfying at least one of the above conditions, the occurrence of the bowing of the film can be reduced more effectively. Thereby, it is possible to obtain the film with excellent planarity and desired in-plane Re.

### BRIEF DESCRIPTION OF DRAWINGS

FIG. 1 is a schematic diagram of a film production line in which a solution casting method of the present invention is performed; and

FIG. 2 is an explanatory view of stretching and relaxing of the film in a tenter dryer.

### BEST MODE FOR CARRYING OUT THE INVENTION

Hereinafter, an embodiment of the present invention is explained in detail. However, the present invention is not limited to the embodiment described here.

### [Materials]

In the present embodiment, cellulose acylate is used as a polymer. As the cellulose acylate, cellulose triacetate (TAC) is especially preferable. Among the cellulose acylate, it is preferable to utilize the one with a degree of the acyl substitution satisfies all of the following formulae (I) to (III):

(I) 2.5≦A+B≦3.0

(II) 0≦A≦3.0

(III) 0≦B≦2.9

In these formulae, A is a degree of substitution of the hydrogen atom of the hydroxyl group to the acetyl group, and B is a degree of substitution of the hydrogen group to the acyl group having 3-22 carbon atoms. Note that the polymer is not limited to the cellulose acylate in the present invention.

The cellulose is constructed of glucose units making β-1,4 combination, and each glucose unit has a liberated hydroxyl group at second, third and sixth positions. The cellulose acylate is a polymer in which part or whole of the hydroxyl groups are esterified so that the hydrogen is substituted by the acyl groups. The degree of substitution for the acyl groups in the cellulose acylate is a degree of esterification at second, third or sixth position in the cellulose. Accordingly, when all (100%) of the hydroxyl groups at the same position are substituted, the degree of substitution at this position is 1.

When the degrees of substitution for the acyl groups at the second, third and sixth positions are respectively described as DS1, DS2 and DS3, a total degree of substitution for the acyl groups at the second, third and sixth positions (that is, DS2+DS3+DS6) is preferably in the range of 2.00 to 3.00, particularly in the range of 2.22 to 2.90 and especially in the range of 2.40 to 2.88. Furthermore, DS6/(DS2+DS3+DS6) is preferably at least 0.28, particularly at least 0.30 and especially in the range of 0.31 to 0.34.

The cellulose acylate of the present invention may contain only one sort of the acyl group, or may contain two or more sorts of the acyl groups. When more than two sorts of the acyl groups are contained, it is preferable that one of the sorts is the acetyl. group. When the total degree of substitution for the acetyl groups and that for other acyl groups at the second, third and sixth positions are respectively described as DSA and DSB, the value DSA+DSB is preferably in the range of 2.22 to 2.90 and particularly in the range of 2.40 to 2.88. Moreover, the DSB is preferably at least 0.30 and especially at least 0.7. Furthermore, in the DSB, the percentage of a substituent at the sixth position is preferably at least 20%, particularly at least 25%, especially at least 30% and most especially at least 33%. Furthermore, the degree of substitution of the cellulose acylate at the sixth position is at least 0.75, particularly at least 0.80 and especially at least 0.85. From the cellulose acylate satisfying the above conditions, a solution (or dope) having a preferable dissolubility can be prepared. Especially when non-chlorine type organic solvent is used, adequate dope can be prepared, since the dope can be prepared so as to have a low viscosity and the filterability becomes higher.

Cellulose, which is a raw material of the cellulose acylate, made from either of linter cotton or pulp cotton is usable in the embodiment, but the one from the linter cotton is preferably used.

The acyl group having at least 2 carbon atoms may be aliphatic group or aryl group, but is not especially restricted. As examples of the cellulose acylate, there are alkylcarbonyl ester, alkenylcarbonyl ester, aromatic carbonyl ester, aromatic alkylcalbonyl ester and the like. Further, the cellulose acylate may be also esters having other substituents. The preferable substituents are propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group and the like. Among them, propionyl group, butanoyl group, dodecanoyl group, octadecanoyl group, t-butanoyl group, oleoyl group, benzoyl group, naphtyl carbonyl group, cinnamoyl group and the like are particularly preferable, and propionyl group and butanoyl group are especially preferable.

Solvent compounds for preparing the dope are aromatic hydrocarbon (for example, benzene toluene and the like), halogenated hydrocarbons (for example, dichloromethane, chlorobenzene and the like), alcohols (for example methanol, ethanol, n-propanol, n-butanol, diethylene glycol and the like), ketones (for example acetone, methylethyl ketone and the like), esters (for example, methylacetate, ethylacetate, n-butanol propylacetate and the like), ethers (for example tetrahydrofuran, methylcellosolve and the like) and the like. Note that the dope in the present invention means a polymer solution produced by dissolving a polymer in solvent, or a polymer dispersion liquid produced by dispersing the polymer into the solvent.

The preferable solvent compounds are the halogenated hydrocarbons having 1 to 7 carbon atoms, and dichloromethane is especially preferable. In view of physical properties such as optical properties, solubility, peelability from a support, mechanical strength of the film and the like, it is preferable to use at least one sort of the solvent compounds having 1 to 5 carbon atoms with dichloromethane. The content of the alcohols is preferably in the range of 2 wt. % to 25 wt. %, and especially in the range of 5 wt. % to 20 wt. % to total solvent compounds in the solvent. As concrete example of the alcohols, there are methanol, ethanol, n-propanol, isopropanol, n-butanol, and the like. It is preferable to use methanol, ethanol, n-butanol or a mixture of them.

Recently, in order to reduce the influence on the environment, composition of solvent with no dichloromethane has been considered. For such solvent, ethers with 4 to 12 carbon atoms, ketones with 3 to 12 carbon atoms, esters with 3 to 12 carbon atoms or alcohols with 1 to 12 carbon atoms, or a mixture of them are preferably used. For instance, a mixed solvent of the methylacetate, acetone, ethanol and n-butanol may be used. The ethers, ketones, esters and alcohols may have a cyclic structure. The solvent compounds having at least two functional groups thereof (—O—, —CO—, —COO— and —OH) may be contained in the solvent.

The cellulose acylate is described in detail in the Japanese patent publication No.2005-104148, and the description of this publication can be applied to the present invention. Moreover, this publication also discloses the solvent and other additives including plasticizers, deterioration inhibitor, UV-absorbing agent, optical anisotropy controlling agent, retardation controller, dye, matting agent, peeling agent and peeling accelerator, in detail.

### [Dope Producing Method]

First of all, a dope is produced from the above-mentioned materials. Along a dope production line, a solvent tank for storing the solvent, a mixing tank for mixing the solvent with the TAC and the like, a hopper for supplying the TAC and an additive tank for storing the additives are provided. The dope production line is also provided with a heater for heating a swelling liquid, which is described later in detail, a temperature controller for controlling a temperature of the produced dope, and a filtration device. The dope production line is further provided with a recovery device for recovering the solvent, and a reproduction device for reusing the recovered solvent. The dope production line is connected to a film production line 10 through a stock tank 11.

At first, a valve is opened to feed the solvent from the solvent tank to the mixing tank. The TAC stored in the hopper is supplied to the mixing tank with measuring and controlling a supplied quantity thereof by a meter. A required quantity of an additive solution, which mainly contains the plasticizers, is supplied from the additive tank to the mixing tank by opening and closing a valve. When the additives are liquid at room temperature, they may be supplied as they are to the mixing tank instead of being supplied as the solution. When the additives are solid, they may be supplied to the mixing tank by use of the hopper. In a case of using two or more kinds of additives, it is possible to store the solution, which plural kinds of additives are dissolved therein, in the additive tank. Alternatively, it is possible to use plural additive tanks, each of which stores the solution of one kind of the additive, so that each additive solution can be supplied to the mixing tank through an individual pipe.

In the above embodiment, the solvent (including the mixed solvent) is first fed to the mixing tank followed by the TAC and finally the additive solution. However, the feeding order is not limited to this. For in stance, a required quantity of the solvent can be fed after the TAC is supplied to the mixing tank with measuring by the meter. In addition, the additive solution is not necessary supplied to the mixing tank at this point. The additive solution can be alternatively mixed to a mixture of the TAC and the solvent (hereinafter such mixture may be referred to as dope as well) in a later step.

A jacket is attached to the mixing tank to cover its periphery. The mixing tank is provided with a first stirrer that rotates by a motor. It is preferable that the mixing tank is further provided with a second stirrer that rotates by a motor. It is preferable that the first stirrer has an anchor blade and the second stirrer is a decentering stirrer. In the jacket, a heating medium is supplied for controlling the temperature in the mixing tank. The temperature is preferably in the range of −10° C. to 55° C. Upon selecting an appropriate type of the first, second stirrer, the swelling liquid, which is produced by swelling the TAC particles in the solvent, is obtained.

Next, the swelling liquid is fed to the heater with use of a pump. The heater is preferably a pipe with a jacket being attached thereto. It is more preferable that the heater has a pressure mechanism for pressuring the swelling liquid. The dope is obtained by dissolving solid content in the swelling liquid with being heated, or being pressured and heated by such heater. Hereinafter the method described above is referred to as the heat-dissolving method. In the heat-dissolving method, the swelling liquid is preferably heated to a temperature in the range of 50° C. to 120° C. Instead of the heat-dissolving method, a cool-dissolving method in which the swelling liquid is cooled to the temperature in the range of −100° C. to −30° C. is also applicable. Either the heat-dissolving method or the cool-dissolving method is appropriately selected, thereby dissolving the TAC in the solvent adequately. After the dope is made to approximately a room temperature by the temperature controller, impurities are removed from the dope by the filtration device. A filter of the filtration device preferably has an average pore diameter of at most 100 μm. Additionally, it is preferably that the filtration is performed at a flow rate of at least 50 L/hr. A dope 12 after the filtration is then fed to the stock tank 11 of the film production line 10 to be stored therein.

According to the above-mentioned method where the swelling liquid is once prepared and the dope is produced from this swelling liquid, time for producing the dope becomes longer as a density of the TAC increases. Longer production time may be disadvantageous in view of production cost. In the above-mentioned method, it is therefore preferable that the dope with the density, which is lower than a desired density, is produced, and the dope is condensed to the desired density.

With the above-mentioned method, the dope 12 with the TAC density in the range of 5 wt. % to 40 wt. % is produced. The TAC density is preferably in the range of 15 wt. % to 30 wt. % and most preferably in the range of 17 wt. % to 25 wt. %. A density of the additives, which mainly contains the plasticizers, is preferably in the range of 1 wt. % to 20 wt. % when total solid content in the dope is 100 wt. %. Dope production method including methods for dissolving materials, raw materials and additives, adding, filtrating, and removing the voids are explained in detail in Japanese Patent publication No.2005-104148. The description of this publication can be applied to the present invention.

### [Solution Casting Method]

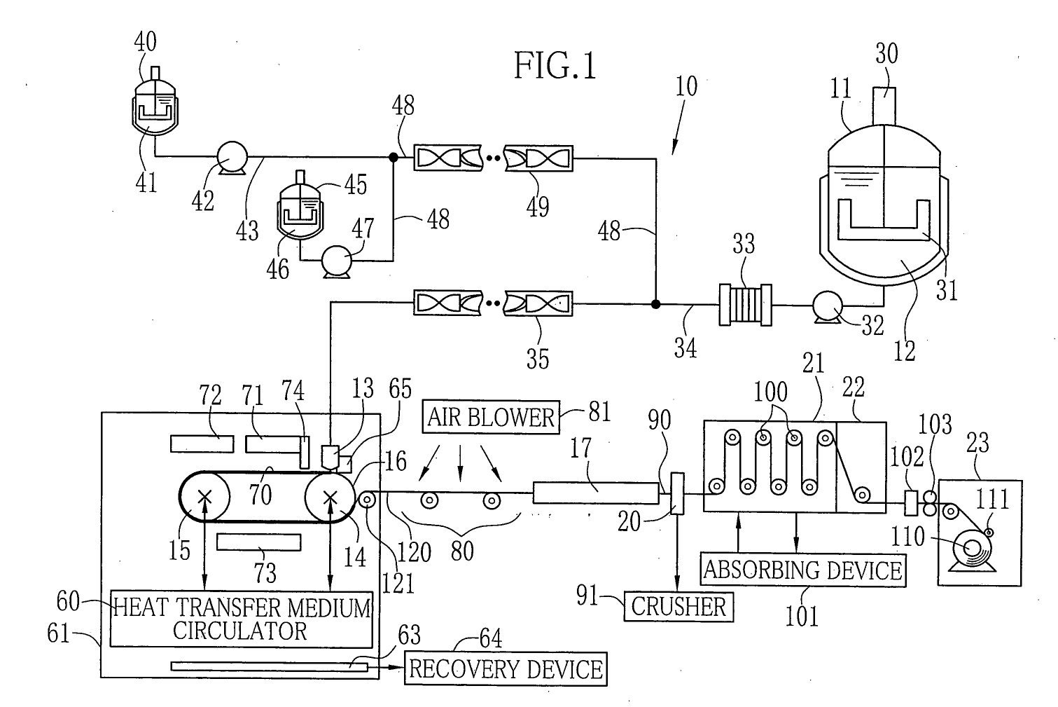

Here, a method for producing a film from the dope 12 described above is explained. FIG. 1 shows the film production line 10. However, the present invention is not limited to the film production line shown in FIG. 1. The film production line is provided with the stock tank 11, a casting die 13, a belt 16 supported by rollers 14, 15, and a tenter dryer 17. Moreover, an edge slitting device 20, a drying chamber 21, a cooling chamber 22 and a winding chamber 23 are arranged in the film production line 10.

The stock tank 11 is provided with a stirrer 31 that rotates by a motor 30. The stock tank 11 is connected to a pipe 34, which includes a pump 32 and a filtration device 33. Moreover, the pipe 34 is connected to a static mixer 35 and a casting die 13 in this order.

A stock tank 40 stores a matting agent liquid 41. The matting agent liquid 41 contains the solvent, polymer and additives that are same as those used for producing the dope 12, and is produced such that it is easily mixed with the dope 12. The stock tank 40 is connected to a pipe 43, which is provided with a pump 42. Note that the matting agent of the present invention is not especially restricted, but preferably contains silica, alumina or the like. The density of the matting agent is also not especially restricted, but is preferably in the range of 0.01 wt. % to 0.50 wt. %.

A stock tank 45 stores a UV-absorbing agent liquid 46. The UV-absorbing agent liquid 46 contains the solvent, polymer and additives that are same as those used for producing the dope 12, and is produced such that it is easily mixed with the dope 12. The stock tank 45 is connected to a pipe 48, which is provided with a pump 47. The pipe 48 is connected with the pipe 43 to which the matting agent liquid 41 is fed. The pipe 48 is also connected to a static mixer 49. The pipe 48 is further connected to the pipe 34 to which the dope 12 is fed at a position downstream from the static mixer 49. Note that the UV-absorbing agent of the present invention is not especially restricted, but is preferably benzotriazol based compounds, benzophenone based compounds and the like. The density of the UV-absorbing agent is also not especially restricted, but is preferably in the range of 0.1 wt. % to 3.0 wt. %.

The matting agent liquid 41 is fed through the pipe 43 to be mixed with the UV-absorbing agent liquid 46. A mixture of the matting agent liquid 41 and the UV-absorbing agent liquid 46 is then stirred evenly to be obtained as an adding liquid.

The adding liquid is mixed with the dope 12 through the pipe 34. A mixture of the adding liquid and the dope 12 is then stirred evenly to be obtained as a casting dope.

A material of the casting die 13 is preferably a precipitation hardened stainless steel whose coefficient of thermal expansion is at most 2×10⁻⁵ (° C.⁻¹). The material having almost same anti-corrosion properties as that of SUS316 in examination of corrosion conducted in electrolyte aqua solution is also preferably used. The material should have the anti-corrosion property to the extent that pitting (holes) does not occur on a gas-liquid interface even if the material is soaked in a mixture liquid of dichloromethane, methanol and water for three months. Moreover, the casting die 13 is preferably finished by grinding more than one month after being molded. Owing to this, the casting dope can be cast on the casting die 13 evenly, thereby preventing the occurrence of seam on a casting film, which is described later in detail. Surface roughness of a contacting surface of the casting die 13 to the dope is preferably at most 1 μm, straightness is at most 1 μm/m in each direction. Clearance of a slit of the casting die 13 is automatically controlled in the range of 0.5 mm to 3.5 mm. An end of a contacting portion of each lip to the dope is processed so as to have a chamfered radius of at most 50 μm through the slit. In the casting die 13, shearing speed of the casting dope is adjusted preferably in the range of 1(1/sec) to 5000(1/sec).

The width of the casting die 13 is not particularly restricted, but is preferably 1.1 to 2.0 times wider than that of the film as the end product. The casting die 13 is preferably provided with a temperature controller so that the temperature therein at the time of producing the film is maintained to a predetermined temperature. The casting die 13 is preferably a coat-hanger type. The casting die 13 is provided with bolts (heat bolts) at a predetermined interval in the widthwise direction so that the thickness of the film is automatically adjusted by the bolts. It is preferable that the bolts set up a profile in accordance with the dope sending amount of the pump 32 (preferably a high-accuracy gear pump) by a predetermined program. It is possible to provide a thickness gauge (for instance, infrared thickness gauge) in the film production line 10 and execute feedback control of the film thickness by an adjustment program based on a profile of the thickness gauge. In the produced film except edge portions, the difference of the thickness at any two apart points is preferably at most 1 μm, and the difference of the minimal thickness value and the maximal thickness value in the widthwise direction is preferably at most 3 μm and more preferably at most 2 μm. The variation of the film thickness from a predetermined film thickness is preferably in the range of ±1.5%.

Lip ends of the casting die 13 are preferably provided with a hardened layer. In order to provide the hardened layer, there are methods of ceramic coating, hard chrome plating, nitriding treatment and the like. When ceramics is used as the hardened layer, the preferable ceramics should make the grinding possible, have low porosity and good resistance to corrosion, and is not brittle. The preferable ceramics should have good adhesion to the casting die 13 but not to the dope. As concrete examples of the ceramics, there are tungsten carbide (WC), Al₂O₃, TiN, Cr₂O₃ and the like. Among them, WC is especially preferable. The hardened layer can be formed by a WC coating in a spraying method.

On both edges of the slit of the casting die 13, the discharged dope is partially dried to be a solid. In order to prevent the solidification of the dope, a supplier (not shown) is preferably provided on the both edges of the slit so that a mixed solvent (for instance, made from 86.5 pts. wt of dichloromethane, 13 pts. wt of acetone and 0.5 pts. wt of n-butanol) to which the dope is dissoluble is supplied to each bead edge and the air-liquid interface of the slit. It is preferable that the mixed solvent is supplied at 0.1 ml/min to 1.0 ml/min to each bead edge so that the casting film is prevented from containing foreign substances. It is preferable that the pump for supplying the dope has a pulsation at most 5%.

Below the casing die 13, the belt 16 is provided with being supported by the rollers 14, 15. The rollers 14, 15 rotate by a driving device (not shown). Along with the rotation of the rollers 14, 15, the belt 16 moves endlessly and circulatory. The moving speed of the belt 16, that is a casting speed is preferably in the range of 10 m/min to 200 m/min. Furthermore, the rollers 14, 15 are connected to a heat transfer medium circulator 60 for keeping a surface temperature of the belt 16 to a predetermined temperature. The surface temperature of the belt 16 is preferably controlled in the range of −20° C. to 40° C. In each roller 14, 15 of the present invention, there is a heat transfer passage (not shown) in which a heat transfer medium at a predetermined temperature is fed, so as to keep the temperature of the rollers 14, 15 to the predetermined temperature.

The width of the belt 16 is not particularly restricted, but is preferably 1.1 to 2.0 times wider than that of the casting dope. It is preferable that the length thereof is preferably 20 m to 200 m and the thickness is 0.5 mm to 2.5 mm. A surface of the belt 16 is preferably polished so as to have the surface roughness of at most 0.05 μm. The belt 16 is preferably made of stainless, and its material is SUS316 so as to have enough resistance to corrosion and strength. Moreover, the thickness unevenness of the belt 16 is preferably at most 0.5%.

It is also possible that the rollers 14, 15 are directly used as a support. In this case, it is preferable that the rollers 14, 15 rotate with accuracy to the extent that the rotational unevenness is regulated to at most 0.2 mm. Here, the average surface roughness of the rollers 14, 15 is preferably at most 0.01 μm. The surfaces of the rollers 14, 15 are finished by the chrome plating so that the surfaces have enough hardness and durability. Note that it is necessary to minimize the defect on the surface of the support (the belt 16 or the rollers 14, 15). Specifically, the surface should not have any pinholes whose diameter is 30 μm or above. The surface may have at most one pinhole whose diameter is 10 μm or above to less than 30 μm per 1 m². The surface may have at most two pinholes whose diameter is less than 10 μm per 1 m².

The casting die 13, the belt 16 and the like are contained in a casting chamber 61. The casting chamber 61 is provided with a temperature regulator (not shown) and a condenser 63. The temperature regulator is for maintaining the temperature inside the casting chamber 61 to a predetermined temperature. The condenser 63 is for condensing vaporized organic solvent. Outside the casting chamber 61 is further provided with a recovery device 64 for recovering the condensed organic solvent. The casting chamber 61 is preferably provided with a decompression chamber 65 for controlling the pressure of a rear side of the bead, which is formed from the casting die 13 to the belt 16. Such decompression chamber is adopted in the present embodiment as well.

Air blowers 71, 72, 73 are provided around the belt 16 so as to evaporate the solvent in a casting film 70. The surface condition of the casting film 70 sometimes changes when the drying air is applied on the casting film 70 just after the formation thereof. In order to reduce the change of the surface condition, the air blower 71 near the casting die 13 is provided with a wind shielding plate 74.

A transfer section 80 is provided with an air blower 81. An edge slitting device 20 that is provided at a position downstream from the tenter dryer 17 is connected to a crusher 91. The crusher 91 crushes both edge portions of a film 90, which are slit off therefrom, into tips.

The drying chamber 21 is provided with a plurality of rollers. An absorbing device 101 is attached to the drying chamber 21. The absorbing device 101 recovers the solvent vapor generated from the drying by absorbing them. In FIG. 1, the cooling chamber 22 is provided at a position downstream from the drying chamber 21. It is also possible to provide a moisture control chamber between the drying chamber 21 and the cooling chamber 22. A forced neutralization device (neutralization bar) 102 is provided at a position downstream from the cooling device 22. The forced neutralization device 102 adjusts charged voltage of the film 90 to the range of, for instance, −3 kV to +3 kV. The position of the forced neutralization device 102 is not limited to downstream from the cooling device 22 as shown in FIG. 1. According to the present embodiment, a pair of knurling rollers 103 is provided at a position downstream from the force neutralization device 102 for providing a knurling to the film 90 at both side edges by emboss processing. Inside the winding chamber 23 is provided with a winding roller 110 for winding up the film 90 and a press roller 111 for controlling a tension at the time of winding the film 90.

Next, one example of producing the film 90 with the film production line 10 as described above is explained. The dope 12 is maintained uniform by the rotation of the stirrer 31 at all times. During the stirring, additives such as the plasticizers can be mixed to the dope 12.

The dope 12 is fed to the filtration device 33 by the pump 32 to be filtrated therein. The matting agent liquid 41 is fed into the pipe 43 by the pump 42. The UV-absorbing agent liquid 46 is fed into the pipe 48 by the pump 47. The matting agent liquid 41 in the pipe 43 is mixed to the UV-absorbing agent liquid 46 in the pipe 48. The mixture of the matting agent liquid 41 and the UV-absorbing agent liquid 46 is then stirred evenly to be the adding liquid. The adding liquid is fed through the pipe 48 and is mixed to the dope 12 in the pipe 34. The mixture of the adding liquid and the dope 12 is then stirred in a static mixer 35 to be the casting dope whose composition is approximately uniform. Mixture ratio of the dope 12, the matting agent liquid 41 and the UV-absorbing agent liquid 46 is not especially restricted, but is preferable in the range of 90 wt. %:5 wt. %:5 wt. % to 99 wt. %:0.5 wt. %:0.5 wt. %.

The casting dope is cast from the casting die 13 onto the belt 16. The rotation of the rollers 14, 15 is preferably controlled such that a tension of the belt 16 becomes 10⁴ N/m to 10⁵ N/m. The difference of the relative speed of the belt 16 and the rollers 14, 15 is controlled to be at most 0.02 m/min. It is preferable that the velocity fluctuation of the belt 16 is at most 0.5% and the meandering of the belt 16 in widthwise direction for one rotation is at most 1.5 mm. In order to control the meandering, it is preferable that a detector (not shown) for detecting the positions of both edges of the belt 16 and a position controller (not shown) for controlling the position of the belt 16 are provided. The position controller executes feedback control based on the detected value from the detector, thereby controlling the position of the belt 16. Moreover, the positional fluctuation owing to the rotation of the roller 14 in horizontal directions of the belt 16 just below the casting die 13 is preferably regulated at most 200 μm. The temperature in the casting chamber 61 is preferably controlled by the temperature regulator (not shown) in the range of −10° C. to 57° C. Furthermore, the vaporized solvent is condensed by the condenser 63 to be recovered by the recovery device 64. The recovered condensed solvent is reused for preparing the dope.

The bead is formed from the casting die 13 to the belt 16. The casting film 70 is formed on the belt 16. The temperature of the casting dope being cast is preferably from −10° C. to 57° C. In order to stabilize the bead, the decompression chamber 65 is preferably provided in the rear side of the bead, so as to control the pressure at a predetermined value. The rear side of the bead is preferably decompressed in the range of −2000 Pa to −10 Pa as compared to its front side. A jacket (not shown) is preferably attached to the decompression chamber 65 so that the temperature inside is maintained to the predetermined temperature. The temperature inside the decompression chamber 65 is not particularly restricted, but is preferably set above a condensing point (condensation temperature) of the used organic solvent. In order to compensate the disorder of the both edges of the bead, an edge suctioning device (not shown) is preferably provided. The airflow of the edge suctioning is preferably in the range of 1 L/min to 100 L/min.

The casting film 70 is conveyed along with the moving belt 16. While being conveyed, the casting film 70 is applied drying air from air blowers 71, 72, 73 to enhance vaporizing the solvent therein. The surface condition of the casting film 70 sometimes changes due to the blowing of the drying air. The wind shielding plate 74 is provided to reduce the change. Note that the surface temperature of the belt 16 is preferably in the range of −20° C. to 40° C.

When having a self-supporting property, the casting film 70 is peeled as a wet film 120 from the belt 16 with support of a peel roller 121. The residual amount of solvent in the casting film 70 at the time of peeling is preferably in the range of 20 wt. % to 250 wt. % on the basis of the solid content. Thereafter, the wet film 120 is transferred to the transfer section 80 provided with the plurality of rollers, to feed into the tenter dryer 17. In the transfer section 80, drying air at the predetermined temperature is fed from the air blower 81 to enhance the drying of the wet film 120. The temperature of the drying air is preferably in the range of 20° C. to 250° C. Note that in the transfer section 80, it is possible to make the rotational speed of the rollers in the upstream side faster than that of the rollers in the downstream side, so as to draw the wet film 120.

The wet film 120 is transferred into the tenter dryer 17 so as to make the drying, while the both side edges thereof are held by clips. It is preferable that inside of the tenter dryer 17 is divided into plural heat zones, and drying condition of each heat zone is appropriately adjusted. The wet film 120 can also be stretched in the widthwise direction inside the tenter dryer 17. It is preferable that the wet film 120 is stretched in at least the longitudinal direction or widthwise direction 0.5% to 300% wider than the former length or width either in the transfer section 80 or the tenter dryer 17. Note that the drying of the wet film 120 in the tenter dryer 17 is explained later in detail.

After the wet film 120 is dried until it comes to have the predetermined residual amount of solvent in the tenter dryer 17, the wet film 120 is sent to the downstream side as the film 90. Then the both edge portions of the film 90 are slit off by an edge slitting device 20. The slit edge portions are conveyed to the crusher 91 with use of a cutter blower (not shown). The crusher 91 crushes the edge portions into tips. These tips are reused for preparing the dope, therefore this method is effective in view of cost saving. Note that this slitting-off process of the film's both edge portions may be omitted. However, it is preferable to execute it anywhere between the processes of casting the dope and winding the film.

The film 90 after its both edge portions are slit off is then transported into the drying chamber 21 to be further dried. The temperature in the drying chamber 21 is not especially restricted, but preferably in the range of 50° C. to 160+ C. In the drying chamber 21, the film 90 is transported with being wound up around the rollers 100. The solvent vapor generated from the drying is absorbed to be recovered by the absorbing device 101. The air from which the solvent vapor is removed is sent back inside the drying chamber 21 as the drying air. Note that it is more preferable that the drying chamber 21 is divided into plural sections so as to vary the drying temperature. If a pre-drying chamber (not shown) is provided between the edge slitting device 20 and the drying chamber 20 to pre-dry the film 90, sudden rise in temperature of the film in the drying chamber 21 is prevented, and thereby the deformation of the film 90 can be reduced.

The film 90 is transported into the cooling chamber 22, and cooled to approximately a room temperature. Note that a moisture control chamber (not shown) may be provided between the drying chamber 21 and the cooling chamber 22. In the moisture control chamber, air controlled to have desired moisture and temperature is fed toward the film 90. Owing to this, the film 90 is prevented from curling or having defect in being wound up.

The forced neutralization device 102 adjusts the charged voltage of the film 90 to the desired range of, for instance, −3 kV to +3 kV. In FIG. 1, the forced neutralization device 102 is disposed in the downstream side from the cooling chamber 22. However, the position of the forced neutralization device 102 is not restricted there. Moreover, the pair of knurling rollers 103 is preferably provided for proving the knurling to the both side edges of the film 90. Note that the unevenness of the area where the knurling is applied to is preferably in the range of lμm to 200 μm.

At last, the film 90 is wound up around the winding roller 110 in the winding chamber 23. At this time, the desired tension is preferably applied to the film 90 by the press roller 111. It is more preferable that the applied tension is gradually changed from starting of the winding to the end of the winding. The length of the film 90 to be wound up is preferably at least 100 m in its longitudinal direction. It is also preferable that the width of the film 90 is at least 600 mm and more preferably from 1400 mm to 1800 mm. Even if the width is more than 1800 mm, the present invention is still applicable. Furthermore, the present invention is also applicable to thin films having thickness in the range of 15 μm to 100 μm.

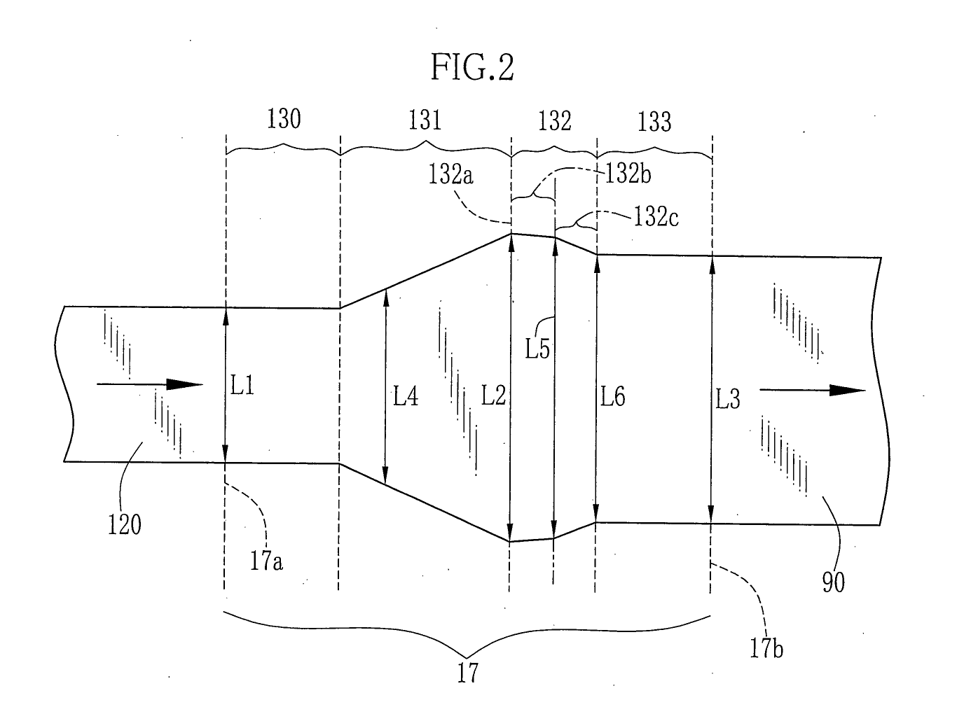

With reference to FIG. 2, stretching and relaxing of the wet film 120 in the tenter drier 17 according to the solution casting method of the present invention is explained. The tenter dryer 17 has four areas. The four areas are: an entrance area 130 in which the width of the wet film 120 is substantially uniform, a stretch area 131 for enlarging the width of the wet film 120, a relaxation area 132 for narrowing the width of the wet film 120 and an exit area 133 in which the film width of the wet film 120 after being relaxed is substantially uniform. The temperature of the tenter dryer 17 is preferably controlled in the range of 60° C. to 180° C.

In the tenter dryer 17, the both side edge portions of the wet film 120 are held by holders (for example clips). The width between the holders is changed so as to make the stretching and relaxing of the wet film 120 in the widthwise direction. The plural clips are connected to a chain. The chain is meshed with a sprocket to be moved endlessly. Along with movement of the chain, the wet film 120 is transported from the entrance area 130 to the exit area 133. Note that widths L1 to L6 of the wet film 120 described below are the distance between the positions at which the side edge portions are held by the clips. The wet film 120 is held by the clips (not shown) at an entrance 17a of the tenter dryer 17. The width of the wet film 120 at the entrance 17a is defined as the width L1 (mm). The wet film 120 is transported to the stretch area 131 to be stretched in the widthwise direction. The maximum width of the wet film 120 in the stretch area 131 is defined as the width L2 (mm). The wet film 120 is then transported to the relaxation area 132 to be relaxed in the widthwise direction. After the relaxing, the width of the wet film 120 is maintained uniform in the exit area 133. This width in the exit area 133 is defined as the width L3 (mm). With maintaining the uniform width L3 (mm), the wet film 120 is released from the clips at an exit 17b and fed out from the tenter dryer 17 as the film 90.

Note that United States Patent Application Publication No. US2005/0073071, the disclosure of which is incorporated by reference herein, discloses the configuration of the tenter dryer in detail, and the disclosure thereof can be applied to the present invention.

The width of the wet film 120 after being transported for 0.1 minute from the position where the holding of the wet film 120 starts, that is the entrance 17a of the tenter dryer 17, is defined as the width L4 (mm). In the present embodiment, the width L4 (mm) is positioned in the stretch area 131, but the position of the width L4 (mm) differs in accordance with the transportation speed of the wet film 120. Therefore, the position of the width L4 (mm) may be, for example in the entrance area 130. A stretch rate of the width of the wet film 120 after being held for 0.1 minute, that is, the rate at which the width L1 (mm) is stretched to the width L4 (mm) is defined as the stretch rate X (%). The stretch rate X (%) is obtained from the following equation: X(%)=((L4−L1)/L1)×100. In the present invention, the stretch rate X (%) is preferably in the range of −10.0% to 1.0%, more preferably −5.0% to 0.5% and most preferably −2.0% to 0.5%. When the stretch rate X (%) is less than −10.0%, the wet film 120 slacks and may contact an inner wall of the tenter dryer 17. As a result, the wet film 120 has a risk of having scratches or wrinkles. On the other hand, when the stretch rate X (%) is more than 1.0%, the wet film 120 is stretched too quickly. As a result, there is a risk that an in-plane retardation (Re) of the wet film 120 increases since the quick stretch causes polymer orientation in the wet film 120. In this case, a bowing may occur.

Note that the stretching is not necessary performed at a constant speed or continuously in the stretch area 131. For example, the stretching and merely the holding may be performed alternately.

The relaxing starts at a relaxation start position 132a of the relaxation area 132. In the relaxation, area 132, relaxation speed becomes fast from a desired position. The area before the relaxation speed changes is defined as a first area 132b and the area after the relaxation speed changes, that is, the relaxation speed becomes fast, is defined as a second area 132c. In the present embodiment, the relaxation area 132 has first and second areas 132b and 132c whose relaxation speed differ from each other. Instead of this configuration, it is possible to perform the relaxing with constant relaxation speed without providing the first and second areas 132b and 132c. It is also possible to provide three or more of such areas in the relaxation area 132 whose relaxation speeds are different from each other.

In the present embodiment, the relaxation speed of the second area 132c is faster than that of the first area 132b, however it is also possible that the relaxation speed of the first area 132b is faster than that of the second area 132c. The width of the wet film 120 at the position where the second area 132c starts is defined as the width L5 (mm). The width of the wet film 120 at the end of the second area 132c is defined as L6 (mm).

A relaxation rate of the width of the wet film 120 per unit time in the first area 132b is obtained from the following equation: {(L2−L5)/L2}×100/T1) where the time elapsed for transporting the wet film 120 in the first area 132b is T1. A relaxation rate of the width of the wet film 120 per unit time in the second area 132c is obtained from the following equation: {(L5−L6)/L5)×100/T2} where the time elapsed for transporting the wet film 120 in the second area 132c is T2. In the present invention, a maximum relaxation rate of the width of the wet film 120 per unit time is defined as a relaxation speed Y (%/min). Accordingly, the relaxation rate per unit time in the second area 132c is defined as the relaxation speed Y (%/min) in the present embodiment.

In the present embodiment, the relaxation speed Y (%/min), which is obtained from the equation: Y(%/min)={(L5−L6)/L5)×100/T2}, is preferably in the range of 0.0%/min to 5.0%/min, more preferably 0.0%/min to 3.0%/min and most preferably 0.0%/min to 1.0%/min. When the relaxation speed Y (%/min) is higher than 5.0%/min, the wet film 120 is shrunk suddenly. As a result, there is a risk that the planarity of the surface of the wet film 120 is deteriorated to have, for instance, shrinkage or wrinkles. When the relaxation speed is regulated constant in the relaxation area 132, the constant value is defied as Y (%/min).

In the present invention, the stretch rate X (%) and the relaxation speed Y (%/min) preferably meet the following equation:

5X+Y<10, more preferably

5X+Y<6.0, even more preferably

5X+Y<5.0 and most preferably

5X+Y<1

The solution casting method of the present invention may be a co-casting method in which two or more kinds of the dopes are cast together so as to form a multi-layer film, or a sequential casting method in which two or more kinds of the dopes are sequentially cast so as to form the multi-layer film. It is also possible to combine these methods. In the co-casting method, a feed block may be attached to the casting die, or a multi-manifold type casting die may be used. A thickness ratio of at least one of uppermost and lowermost layers of the multi-layer casting film on the support is preferably in the range of 0.5% to 30% to the total thickness thereof. Moreover, in the co-casting method, it is preferable that the lower viscosity dope entirely covers over the higher viscosity dope when the dopes are cast onto the support from the die slit. Furthermore, in the co-casing method, it is preferable that the inner dope is covered with dope whose alcohol contents are larger than that of the inner dope in the bead, which is formed from the die slit to the support.

Note that Japanese patent publication No. 2005-104148 teaches in detail the structure of the casting die, the decompression chamber and the support, drying conditions in each processes such as the co-casting, the peeling and the stretching, a handling method, a winding method after the correction of planarity and curling, a recovering method of the solvent, a recovering method of the film and the like. The description of the above publication can be applied to the present invention.

### [Characteristics, Measuring Method]

This publication No. 2005-104148 teaches the characteristics and the measuring method of the cellulose acylate film, which may be applied to the present invention.

It is preferable to make a surface treatment on at least one surface of the cellulose acylate film. Preferably, the surface treatment is at least one of glow discharge treatment, atmospheric pressure plasma discharge treatment, UV radiation treatment, corona discharge treatment, flame treatment, and acid or alkali treatment.

### [Functional Layer]

(Antistatic, Hardened layer, Antireflection, Easy adhesion, Antiglare)

A primary coating may be made over at least one surface of the cellulose acylate film.

Moreover, it is preferable to provide other functional layers for the cellulose acylate film as a film base so as to obtain a functional material. The functional layers may be at least one of an antistatic agent, a cured resin layer, an antireflection layer, an adhesive layer for easy adhesion, an antiglare layer and an optical compensation layer.

Preferably, the functional layer contains at least one sort of the matting agent in the range of 0.1 mg/m² to 1000 mg/m². Moreover, the functional layer preferably contains at least one sort of the antistatic agent in the range of 1 mg/m² to 1000 mg/m². Conditions and methods of performing a surface treatment and providing a functional layer with several functions and characteristics are described in Japanese patent publication No. 2005-104148.

(Use)

The cellulose acylate film can be used as the protective film in a polarizing filter. To obtain a LCD, two polarizing filters, in each of which the cellulose acylate film is adhered to a polarizer, are disposed so as to sandwich a liquid crystal layer. The arrangement of the liquid crystal layer and the polarizer is not limited to this, but may be of any known arrangements. The publication No. 2005-104148 discloses TN type, STN type, VA type, OCB type, reflection type, and other examples of the LCD in detail. These types can be applied to the present invention. Moreover, the publication teaches the cellulose acylate film provided with an optical anisotropic layer and that provided with antireflective and antiglare functions. Furthermore, the publication describes to provide the cellulose acylate film with adequate optical functions to obtain a biaxial cellulose acylate film and to use it as an optical compensation film. The obtained biaxial cellulose acylate film can be simultaneously used as the protective film in the polarizing filter. The restriction thereof described in the publication No. 2005-104148 can be applied to the present invention.

In addition, a polymer film having superior optical characteristics can be obtained according to the present invention. The present invention is especially effective to a cellulose triacetate film (TAC film). The TAC film can be used as a base film of a photosensitive material or the protective film in the polarizing filter. The TAC film is also used as the optical compensation film for widening a view angle of the LCD used for a TV monitor. At this time, the TAC film is useful since it doubles as the protective film in the polarizing filter. Accordingly, the TAC film can be used for an IPS (In-Plane Switching) mode, an OCB (Optionally Compensatory Bend) mode, a VA (Vertically Aligned) mode and the like as well as for a conventional TN (Twisted Nematic) mode.

### EXAMPLE

Hereinafter, an example of the present invention is explained. However, the present invention is not limited to the example. In this example, Experiments 1 to 6 were performed. The explanation of Experiment 1 of the present invention is made in detail, and the same explanations of Experiments 2 to 6 of the preset invention and Comparative Experiments 7 to 9 are omitted. Moreover, the conditions and the results of the experiments are shown in Table 1.

Compositions of the dope used for producing the film are described below.

{Experiment 1}

### [Preparation of Dope]

Formulation of the compounds used for preparing the dope 12 is listed below.

| | | |
|---|---|---|
| Cellulose triacetate | 89.3 | wt. % |
| (degree of substitution, 2.8) | | |
| Plasticizer A (triphenylphosphate) | 7.1 | wt. % |
| Plasticizer B (biphenyldiphenylphosphate) | 3.6 | wt. % |

These solid materials (solute) were added to a mixed solvent of following compounds:

| | | |
|---|---|---|
| Dichloromethane | 92 | wt. % |
| Methanol | 8 | wt. % |

The mixture of the solid materials and the mixed solvent was stirred to make the dissolution so as to obtain the dope 12, in which the content of the solid materials was 19.3 wt. %. The dope 12 was filtered first by a filter paper (#63LB produced by Advantec Toyo Kaisha, Ltd.), followed by a sintered metallic filter (06N with nominal pore diameter of 10 μm produced by Nippon Seisen Co., Ltd.) and finally a mesh filer before it was stored in the stock tank 11.
[Cellulose triacetate]

In the cellulose triacetate (TAC) used here, the residual amount of acetic acid was equal to or less than 0.1 wt. %. The rate of content of Ca was 58 ppm, Mg was 42 ppm, Fe was 0.5 ppm, release acetic acid was 40 ppm and acetate ion was 15 ppm. In addition, the degree of the substitution of the hydrogen of the hydroxyl group at sixth position for the acetyl groups was 0.91. Among all of the acetyl groups, 32.5% thereof was composed of the acetyl groups that were substituted from the hydrogen of the hydroxyl group at sixth position. In the TAC, the content of acetone extract was 8 wt. %, and the ratio of weight-average molecular weight to number-average molecular weight thereof was 2.5. In addition, in the obtained TAC, yellow index was 1.7, haze was 0.08 and degree of transparency was 93.5%. The material of the TAC is the cellulose, which is made from the cotton.

[Matting agent liquid]

According to formulation described below, the matting agent liquid 41 was prepared. Note that the TAC was same as the one used for preparing the dope 12.

| | | |
|---|---|---|
| Silica | 0.67 | wt. % |
| (Aerozil R972 produced by Nippon Aerozil Co., Ltd.) | | |
| Cellulose triacetate | 2.93 | wt. % |
| Triphenylphosphate | 0.23 | wt. % |
| Biphenyldiphenylphosphate | 0.12 | wt. % |
| Dichloromethane | 88.37 | wt. % |
| Methanol | 7.68 | wt. % |

The above compounds were mixed and dissolved by an attritor such that the prepared matting agent liquid 41 has the volume average particle diameter of 0.7 μm. After that, the matting agent liquid 41 was filtered by a filter AstroPore 10 produced by Fuji Photo Film Co., Ltd. and stored in the stock tank 40.
[UV-absorbing agent liquid]

According to formulation described below, the UV-absorbing agent liquid 46 was prepared. Note that the TAC was same as the one used for preparing the dope 12

| | | |
|---|---|---|
| 2(2′-hydroxy-3′,5′-di-tert-butylphenyl)-5-chlorobenzo- | 5.83 | wt. % |
| triazol | | |
| 2(2′-hydroxy-3′,5′-di-tert-amylphenyl)benzotriazol | 11.66 | wt. % |
| Cellulose triacetate | 1.48 | wt. % |
| Triphenylphosphate | 0.12 | wt. % |
| Biphenyldiphenylphosphate | 0.06 | wt. % |
| Dichloromethane | 74.38 | wt. % |
| Methanol | 6.47 | wt. % |

The UV-absorbing agent liquid 46 prepared from the above compounds was filtered by the filter AstroPore 10 produced by Fuji Photo Film Co., Ltd. and stored in the stock tank 45.

In addition, a mixed solvent A made from 86.5 pts. wt of dichloromethane, 13 pts. wt of acetone and 0.5 pts. wt of 1-butanol was prepared.

The matting agent liquid 41 was fed into the pipe 43 by the pump 42, whereas the UV-absorbing agent liquid 46 was fed into the pipe 48 by the pump 47. After the matting agent liquid 41 is mixed with the UV-absorbing agent liquid 46, the mixture thereof was stirred by the static mixer 49 to obtain the adding liquid. The dope 12 was fed into the pipe 34 by the pump 32 and filtered by passing through the filtration device 33. The adding liquid was mixed to the dope 12 in the pipe 34. The mixture of the adding liquid and the dope 12 was then stirred in the static mixer 35, thereby obtaining the casting dope.

The film 90 was produced with use of the film production line 10 shown in FIG. 1. The pump 32 had a function to intensify pressure at its upstream side. The pump 32 fed the dope 12 such that the pressure at the upstream side became 0.8 MPa in accordance with a feedback control of an inverter motor. The pump 32 had volumetric efficiency at 99.2% and degree of variability of discharge rate at most 0.5%. In addition, discharge pressure of the pump 32 was 1.5 MPa.

The casting die 13 was 1.8 m in width. The casting was made with regulating a flow rate of the casting dope from the casting die 13, such that the thickness of the produced film becomes 80 μm and the width of the casting becomes 1700 mm. Note that the casting speed was in the range of 45 m/min to 55 m/min. In order to regulate the temperature of the casting dope to 36° C., the jacket (not shown) was provided with the casting die 13, and a heat transfer medium fed into the jacket was controlled to 36° C. at an entrance of the jacket.

While producing the film, the temperatures of the casting die 13 and pipes are kept at 36° C. The casting die 13 was coat-hanger type. The casting die 13 was provided with the heat bolts with pitch of 20 mm, and had a mechanism to automatically adjust the thickness of the film with use of the heat bolts. The heat bolts could set up the profile in accordance with the dope sending amount of the pump 32 by the predetermined program. In addition, the heat bolts could execute feedback control of the film thickness by the adjustment program based on the profile of the thickness infrared gauge (not shown) that is provided on the film production line 10. In the film except the 20 mm edge portions, the difference of the thickness at any two points apart at 50 mm was at most 1 μm, and the difference of the minimal thickness value and the maximal thickness value in the widthwise direction was at most 3 μm. The variation of the film thickness from the predetermined film thickness was controlled to be in the range of ±1.5%.

In a primary side from the casting die 13, the decompression chamber 65 was disposed. The decompression rate of the decompression chamber 65 was adjustable depending on the casting speed, such that a pressure difference falls into the range of 1 Pa to 5000 Pa between upstream and downstream sides of the bead. The pressure difference was set accordingly so that the length of the bead was in the range of 20 mm to 50 mm. The temperature of the decompression chamber 65 was adjustable to be higher than the condensation temperature of the vaporized organic solvent around the casting area. At the front and rear sides of the bead near the slit of the casting die 13, a labyrinth packing (not shown) was provided. Moreover, openings were provided at both edges of the slit of the casting die 13. In order to compensate the disorder of the both edges of the bead, the edge suctioning device (not shown) was provided on the casting die 13.

The material of the casting die 13 was the precipitation hardened stainless whose coefficient of thermal expansion is at most 2×10⁻⁵(° C.⁻¹). This marital also had almost same anti-corrosion properties as that of SUS316 in examination of corrosion conducted in electrolyte aqua solution. Moreover, the material had the anti-corrosion property to the extent that pitting (holes) does not occur on the gas-liquid interface even if the material is soaked in the mixture liquid of dichloromethane, methanol and water for three months. The surface roughness of the contacting surface of the casting die 13 to the dope was at most 1 μm, the straightness was at most 1 μm/m in each direction and the clearance of the slit was 1.5 mm. The end of the contacting portion of each lip of the casting die 13 to the dope was processed so as to have the chamfered radius of at most 50 μm through the slit. In the casting die 13, the shearing speed was in the range of 1(1/sec) to 5000(1/sec). At the end of each lip, the hardened layer was formed by WC coating in the spraying method.

On the both edges of the die slit, the discharged dope is partially dried to be a solid. In order to prevent the solidification of the dope, the mixed solvent A for dissolving the casting dope was supplied at 0.5 ml/min to each bead edge and the air-liquid interface of the slit. The pump for supplying the dope had the pulsation at most 5%. In addition, the pressure in the rear side (or the upstream side) of the bead was decreased from that of the front side thereof by 150 Pa. In order to make the temperature in the decompression chamber 65 constant at the predetermined temperature, the jacket (not shown) was attached to the decompression chamber 65. Into the jacket, a heat transfer medium whose temperature was regulated to 35° C. was fed. The airflow rate of the edge suctioning was adjustable in the range of 1 L/min to 100 L/min, and in this embodiment, the air flow rate was appropriately regulated in the range of 30 L/min to 40 L/min.

The belt 16, which was used as the support, was a stainless endless belt with width of 1.9 m and length of 70 m. The thickness of the belt 16 was 1.5 mm and its surface was polished such that the surface roughness becomes at most 0.05 μm. The material of the belt 16 was SUS316 and had enough corrosion resistance and strength. The thickness unevenness of the belt 16 was at most 0.5%. The belt 16 was rotated by the two rollers 14, 15. The difference of the relative speed of the rollers 14, 15 and the belt 16 was at most 0.01 m/min. At this time, the velocity fluctuation of the belt 16 was at most 0.5%. The rotation of the bet 16 was regulated with detecting the positions of its both edges such that the meandering of the belt 16 in widthwise direction for one rotation was regulated to at most 1.5 mm. The positional fluctuations in horizontal directions of the lips and the belt 16 just below the casting die 13 were regulated to at most 200 μm. The belt 16 was provided in the casting chamber 61 having a wind pressure controller as the temperature regulator (not shown). Onto the belt 16, the casting dope was cast from the casting die 13.

Into the rollers 14, 15 were fed the heat transfer medium so as to perform the temperature regulation of the belt 16. The roller 14 on the side of the casting die 13 was fed with the heat transfer medium at 5° C., whereas the other roller 15 was fed with the heat transfer medium at 40° C. The surface temperature of the middle portion of the belt 16 just before the casting was 15° C., and the temperature difference between both side edges of the belt 16 was at most 6° C. It was preferable that the belt 16 has no defect on the surface, but was permissible within the limits of: no pinholes whose diameter is 30 μm or above, at most one pinhole whose diameter is 10 μm or above to less than 30 μm per 1 m² and at most two pinholes whose diameter is less than 10 μm per 1 m².

The casting dope was cast onto the belt 16 to form the casting film 70. The drying air, which flows parallel to the casting film 70, was fed at first to dry the casting film 70. The air blower 71, which is provided above the belt 16, at the upstream side of the casting film 70, fed the dying air at 140° C. The air blower 72, which is provided above the belt 16, at the downstream side of the casting film 70, fed the drying air at 140° C. The air blower 73, which is provided below the belt 16, fed the drying air at 65° C. The oxygen concentration in the drying atmosphere above the belt 16 was maintained to 5 vol % by replacing the air with nitrogen gas. In addition, the condenser 63 was provided in the casting chamber 61 so as to condense the vaporized organic solvent. The temperature at an entrance of the condenser 63 was set at −3° C.

The static pressure fluctuation near the casting die 13 was regulated to equal to or lower than ±1 Pa. When having the self-supporting property, the casting film 70 was peeled as the wet film 120 from the belt 16 with support of the peel roller 121. In order to reduce the peeling defect, speed ratio of the peeling speed to the moving speed of the belt 16 was regulated in the range of 100.1% to 110%. The solvent vapor generated by the drying was condensed by the condenser 63, in which the temperature was maintained to −3° C., and then recovered by the recovery device 64. The water content in the solvent was regulated to at most 0.5 wt. %. The drying air from which the solvent vapor was removed was heated again and reused as the drying air. The wet film 120 was transferred into the tenter dryer 17 by the rollers of the transfer section 80. During the transporting in the transfer portion 80, the drying air at 60° C. was fed from the air blower 81 onto the wet film 120.

In the tenter dryer 17, the wet film 120 was transported with its both side portions held by the clips while dried with the drying air. The clips were cooled with the heat transfer medium at 20° C. The clips were moved by the chain that is meshed with the sprocket. The velocity fluctuation of the sprocket was at most 0.5%. In the tenter dryer 17, heating air at 90° C. was controlled such that its wind speed in the widthwise direction becomes constant. The heating air is fed out into a normal direction of the wet film 120 through nozzles (not shown), which are disposed with spaces in between. Gas composition in the drying air was set such that the gas is saturated at −10° C. The residual amount of solvent in the film 90 at the exit 17b of the tenter dryer 17 was in the range of 14 wt. % to 17 wt. %. In the tenter dryer 17, the wet film 120 is stretched in its widthwise direction while being transported. Note that an ultimate stretch rate, that is, the rate at which the width L1 (mm) is stretched to the width L3 (mm) was regulated to 4.5% (=(L3−L1)/L1}×100). In addition, the stretch rate of the wet film 120 from the peel roller 121 to the entrance 17a of the tenter dryer 17 was regulated to 103.0%.

The solvent vapor generated in the tenter dryer 17 was condensed by a condenser, in which the temperature was maintained to −3° C. The water content in the condensed solvent was regulated to at most 0.5 wt. % to be reused. The film 120 was then sent out from the tenter dryer 17 as the film 90.

The stretch rate X (%: =(L4−L1)/L1}×100) of wet film 120 after being held for 0.1 minute (=6 seconds), that is the stretch rate of the width of the wet film 120 stretched from the width L1 (mm) to the width L4 (mm), was regulated to 0.11%. In addition, the relaxation speed of the wet film 120 in the relaxation area 132 was regulated constant so that the relaxation speed Y (%/min: =(L5−L6)/L5}×100/T2) of the width of the wet film 120 becomes 0%/min. In this case, the value obtained from the equation, 5X+Y, was 0.53.

Both edge portions of the film 90 was slit by the edge slitting device 20 within 30 seconds after passing through the exit 17b of the tenter dryer 17. The slit edge potions, which are 50 mm from each end of the film 90, were sent into the crusher 91 by the cutter blower (not shown). The crusher 91 crushed the edge portions into tips with the average diameter of 80 mm² The tips were reused as the material for preparing the dope with TAC flakes. The oxygen concentration in the drying atmosphere in the tenter dryer 17 was maintained to 5 vol % by replacing the air with nitrogen gas. Before drying at high temperature in the drying chamber 21, which is explained later, the preheating of the film 90 was made in a pre-drying room (not shown) where the drying air at 100° C. was fed.

The film 90 was dried at high temperature in the drying chamber 21. The drying chamber 65 was divided into four zones in accordance with temperature of the drying air. From the upstream side, the drying air at 120° C., 130° C., 130° C. and 130° C. were fed from air blowers (not shown). The tension in transporting the film 90 by the rollers 100 was 100N/m, and the drying was made for about 5 minutes so that the residual amount of solvent ultimately becomes 0.3 wt. %. The wrap angle (center angle of arc) of the rollers 100 was in the range of 80° to 190°. The material of the rollers 100 was aluminum or carbon steel, and a hard chrome coating was made on a surface or periphery. Two types of rollers were used as the rollers 100. One had flat surface and the other had dimpled surface. The positional fluctuation (or eccentricity) in the rotation of the rollers 100 was at most 50 μm, and the bending of the rollers 100 at the tension of 100N/m was at most 0.5 mm.

The solvent vapor contained in the drying air was absorbed and recovered by the absorbing device 101. The absorpive agent used here was activated carbon. The adsorption was made with use of dry nitrogen. The water content in the recovered solvent was regulated to at most 0.3 wt. % to be reused as the solvent for preparing the dope. The drying air includes not only the solvent vapor but also other compounds such as plasticizer, UV-absorbing agent and compounds with high boiling points. Therefore the other compounds are removed by a cooling device and a pre-adsorber, and recycled. Then the adsorption and desorption conditions were set such that VOC (volatile organic compounds) in the exhaust gas becomes at most 10 ppm. Among the entire solvent vapor, 90 wt. % thereof was recovered with the condensation method. Majority of the rest was recovered with the adsorption.

The dried film 90 was then transported into a first moisture control chamber (not shown). In a transfer section between the drying chamber 21 and the first moisture control chamber, the drying air at 110° C. was fed. Air in the first moisture control chamber was regulated to have the temperature at 50° C. and the dew point at 20° C. After that, the film 90 was transported into a second moisture control chamber (not shown) where the occurrence of the curl of the film 90 is controlled. In the second moisture chamber, air with the temperature at 90° C. and the humidity at 70% was directly fed onto the film 90.

After the moisture was controlled, the film 90 was cooled down to 30° C. in the cooling chamber 22. The film 90 was then slit at its side edge portions again by an edge slitting device (not shown). The force neutralization device 102 was provided in the downstream side of the cooling device to adjust the charged voltage of the film 90 during the transporting was always regulated in the range of −3 kV to +3 kV. The knurling of the both sides of the film 90 was made by the pair of knurling rollers 103. The knurling was performed by embossing process from one side of the film 90. The width of the knurling was 10 mm, and the pressure level of the knurling rollers 103 were set up such that the average height of the formed knurling becomes 12 μm higher than the averaged thickness of the film 90.

Thereafter, the film 90 was transported into the winding chamber 23 in which the temperature was at 28° C. and the humidity was 70%. Moreover, an ionizer (not shown) was disposed in the winding chamber 23 so that the charged voltage was in the range of −1.5 kV to +1.5 kV. Thus the film 90 was obtained to have the thickness of 80 μm and the width of 1340 mm as the end product.

### [Measurement of Axial Misalignment]

An axial misalignment angle, which is an angle of the slow axis to the lengthwise direction, of the film 90 was measured with use of KOBRA-21DH (produced by Oji Scientific Instrument Co., Ltd.). Samples were obtained at the position 15 cm apart from one edge of the produced film 90 (hereinafter film edge 1), and at a center of the produced film 90. The samples were accurately cut into a 5 cm square with use of a cutting plotter. The axial misalignment angle of each sample was measured by the KOBRA-21DH. An axial misalignment value was then obtained from the difference of the axial misalignment angles between the film edge 1 and the center of the film 90. The obtained value, which was defined as the axial misalignment value 1, was 2.2°. Another sample was obtained at the position 5 cm apart from one edge of the produced film 90 (hereinafter film edge 2) and its axial misalignment angle was measured in the same manner as the film edge 1. Then an axial misalignment value was obtained from the difference of the axial misalignment angles between the film edge 2 and the center of the film 90. The obtained value, which was defined as the axial misalignment value 2, was 8.7°.

Evaluation of the film 90 was made with four grindings: Excellent, Good, Normal and Bad. When the axial misalignment values 1 and 2 were both less than 10°, the film was evaluated as Excellent. When the axial misalignment value 1 was less than 10° and the axial misalignment value 2 was 10° or above to less than 45°, the film was evaluated as Good. When the axial misalignment value 1 was less than 10° and the axial misalignment value 2 was 45° or above, the film was evaluated as Normal. When the axial misalignment value 1 was 10° or above, the film was evaluated as Bad.

{Experiments 2 to 5}

Experiments 2 to 5 were conducted under the same conditions of the experiment 1, except for the values of the stretch rate X (%) and the relaxation speed Y (%/min) as shown in Table 1. The evaluations of the film 90 obtained in any of the experiments 2 to 5 were Excellent.

{Experiment 6}

Experiment 6 was conducted under the same conditions of the experiment 1, except for the values of the stretch rate X (%) and the relaxation speed Y (%/min) as shown in Table 1. The evaluation of the film 90 obtained in the experiment 6 was Good.

{Experiments 7 and 8}

Experiments 7 and 8 were conducted under the same conditions of the experiment 1, except for the values of the stretch rate X (%) and the relaxation speed Y (%/min) as shown in Table 1. The evaluations of the film 90 obtained in any of the experiments 7 to 8 were Normal.

{Experiment 9}

Experiment 9 was conducted under the same conditions of the experiment 1, except for the values of the stretch rate X (%) and the relaxation speed Y (%/min) as shown in Table 1. The evaluation of the film 90 obtained in the experiment 9 was Bad.

TABLE 1

| | Ultimate | Stretch | Relaxation | | Axial | Axial | |
|---|---|---|---|---|---|---|---|
| | stretch | rate | speed | | misalignment | misalignment | |
| | rate | X | Y | | value 1 | value 2 | |
| | (%) | (%) | (%/min) | 5X + Y | (°) | (°) | Evaluation |
| Ex. 1 | 4.5 | 0.11 | 0 | 0.53 | 2.2 | 8.7 | Excellent |
| Ex. 2 | 4.5 | 0.00 | 0 | 0.00 | 1.7 | 6.5 | Excellent |
| Ex. 3 | 3.2 | −0.93 | 4.91 | 0.26 | 4.1 | 5.1 | Excellent |
| Ex. 4 | 3.7 | −0.44 | 4.91 | 2.71 | 2.3 | 7.7 | Excellent |
| Ex. 5 | 3.2 | 0 | 4.91 | 4.91 | 1.8 | 4.5 | Excellent |
| Ex. 6 | 4.5 | 0.51 | 3.09375 | 5.66 | 4.3 | 38.0 | Good |
| Ex. 7 | 4.5 | 2.88 | 0 | 14.41 | 5.2 | 68.2 | Normal |
| Ex. 8 | 4.5 | 2.88 | 3.09 | 17.50 | 6.4 | 76.3 | Normal |
| Ex. 9 | 4.5 | 2.88 | 24.75 | 39.16 | 16.2 | 75.7 | Bad |

As shown in Table 1, the film 90 obtained by the experiments 1 to 7, in which the equation of 5X+Y<6.0 was satisfied, was preferable since the axial misalignment values were small. In the experiments 1 to 5 where the stretch rate X (%) was less than 0.50%, the obtained film 90 was particularly preferable. Accordingly, it was found that the bowing is prevented by reducing or not performing the stretching of the wet film 120 for 0.1 minute after the wet film 120 was held by the clips provided in the tenter dryer 17.

Various changes and modifications are possible in the present invention and may be understood to be within the present invention.

### INDUSTRIAL APPLICABILITY

The present invention is preferably applied to devices for requiring high retardation value of the polymer film, especially to devices associated to liquid crystals.

1. A solution casting method, comprising the steps of:
casting a dope onto a support to form a casting film, said dope containing a polymer and a solvent;
peeling said casting film from the support as a film; and
holding both side edge portions of said film by a holding device and drying said film while transporting, said holding-drying step including
stretching said film in a widthwise direction to enlarge a width of said film,
relaxing said film in said widthwise direction to narrow said width of said film;
wherein when said width of said film at the time of starting said holding is La (mm) and said width of said film after being held for 0.1 minute is Lb (mm), a stretch rate of said width of said film after being held for 0.1 minute is defined as a stretch rate X (%), which is obtained from an equation: {((La−Lb)/La}×100, whereas a maximum relaxation rate of said width of said film per unit time in said relaxing step is defined as a relaxation speed Y (%/min), said stretch rate X (%) and said relaxation speed Y (%/min) satisfy the following equation:
5X+Y<10

2. A solution casting method described in claim 1, wherein said stretch rate X (%) is in the range of −10.0% to 1.0%.

3. A solution casting method described in claim 1, wherein said relaxation speed Y (%/min) is in the range of 0.0%/min to 5.0%/min.

4. A solution casting method described in claim 1, wherein said polymer is cellulose acylate.
